(19) United States
(12) Patent Application Publication
(10) Pub. No.: US 2017/0309937 A1
(43) Pub. Date: Oct. 26, 2017

(54) SECURE FUEL CELL SYSTEM

(71) Applicant: Safran Power Units, Toulouse (FR)

(72) Inventor: Fabien BOUDJEMAA, Garches (FR)

(73) Assignee: SAFRAN POWER UNITS, Toulouse (FR)

(21) Appl. No.: 15/513,322

(22) PCT Filed: Sep. 18, 2015
(86) PCT No.: PCT/FR2015/052514

§ 371 Date: Mar. 22, 2017

(30) Foreign Application Priority Data
Sep. 23, 2014 (FR) 1458959

(51) Int. Cl. H01M 8/04746; H01M 8/04119; H01M 8/04007; B64D 41/00

(52) U.S. Cl. CPC H01M 8/04761; H01M 8/04067; B64D 41/00; H01M 8/04164; B64D 2041/005; H01M 2250/20

(57) ABSTRACT

An assembly including a fuel cell arranged in a housing, the fuel cell includes an anode having an admission and an anode discharge, and a cathode having an oxygen admission and a cathode discharge, the assembly includes the housing and a sealed enclosure in which the fuel cell is arranged and configured in such a manner that the gas discharged by the fuel cell is discharged into the sealed enclosure so as to generate an over-pressure of oxygen-depleted air inside the sealed enclosure.

### GENERAL TECHNICAL FIELD

The present invention relates to the field of fuel cells, and more particularly it relates to fuel cells for applications in the field of aviation.

### STATE OF THE ART

Although fuel cells present major advantages in terms of energy generation, they remain little used in certain fields, such as aviation, because of the very high safety requirements that apply thereto.

Specifically, in high temperature fuel cells, e.g. of the proton exchanger membrane type, a problem relates to leaks of hydrogen from the stack.

The presence of hydrogen is a major risk factor, because of hot points and sources of electricity that can lead to ignition or explosion under certain circumstances.

It can thus readily be understood that such risks are not acceptable, in particular in the field of aviation, and consequently that it is necessary to develop safety systems for fuel cells in order to remedy such leaks of hydrogen.

At present, the solutions used consist in ventilating the zone in which the fuel cell is arranged so as to dilute any leaks of hydrogen into the ambient medium, or to have hydrogen detectors that are coupled to a system capable of sweeping with an inert gas, such as nitrogen, in the event of detecting a hydrogen leak.

Nevertheless, those solutions are not very satisfactory, in that they limit the locations that can receive fuel cells to certain zones of an aircraft, and in particular zones outside the cabin.

Those solutions also require an external fan to drive air. Unfortunately, any failure of the fan would then require the fuel cell to be stopped in order to make the system safe.

### SUMMARY OF THE INVENTION

The present invention thus seeks to remedy these problems, at least in part, and proposes an assembly comprising a fuel cell arranged in a housing, the fuel cell comprising an anode having an admission and an anode discharge, and a cathode having an oxygen admission and a cathode discharge, the assembly being characterized in that the housing comprises a sealed enclosure in which the fuel cell is arranged and configured in such a manner that the gas discharged by the fuel cell is released into the sealed enclosure so as to generate an over-pressure of oxygen-depleted air inside the sealed enclosure.

In a particular embodiment, the assembly further comprises a condenser arranged inside the sealed enclosure and connected to the cathode discharge, the condenser being configured so as to collect water from the cathode discharge and evacuate it to the outside of the housing, with the air from the cathode discharge being evacuated into the sealed enclosure of the housing.

Typically, the housing includes a rated valve configured to define a maximum pressure within the sealed enclosure, which pressure is higher than a predetermined ambient pressure.

By way of example, the oxygen admission of the cathode is connected to the ambient medium by means of a check valve.

Typically, the fuel cell is a proton exchange membrane fuel cell.

Typically, the fuel cell further comprises a cooling system including a heat exchanger arranged outside the sealed enclosure of the housing.

The invention also provides an aircraft including an assembly as defined above, arranged in a volume of the aircraft that is pressurized at an ambient pressure.

### SUMMARY OF THE FIGURES

Other characteristics, objects, and advantages of the invention appear from the following description, which is purely illustrative and non-limiting, and which should be read with reference to the accompanying drawing, in which:

FIG. 1 is a diagram of an assembly in an aspect of the invention; and

FIG. 2 is a diagram showing the operation of such an assembly.

### DETAILED DESCRIPTION

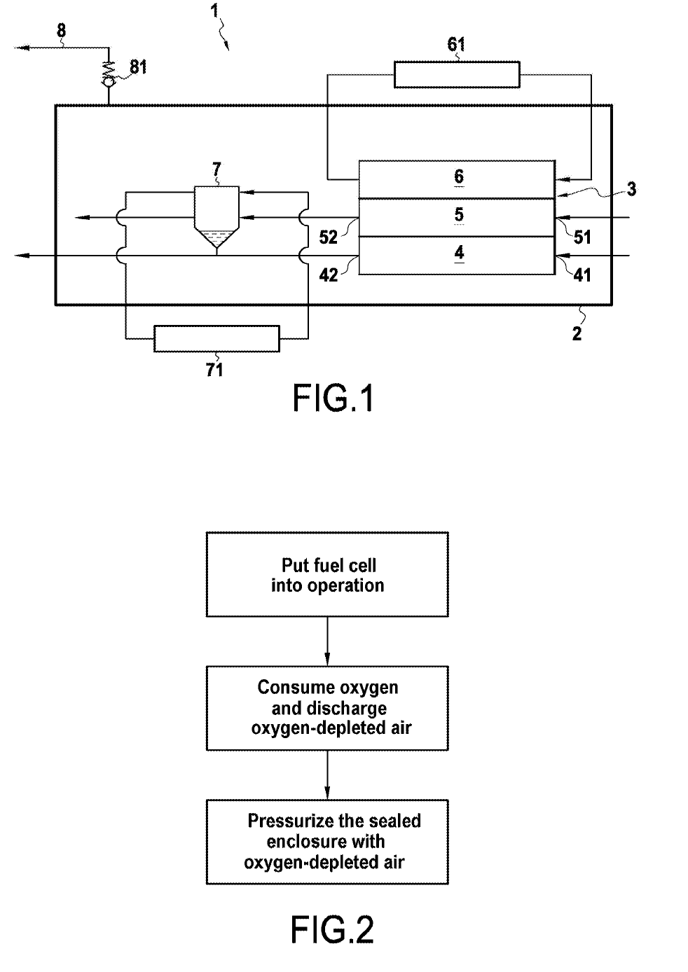

FIG. 1 is a diagram showing an assembly 1 in an aspect of the invention.

The assembly 1 as shown comprises a housing 2 containing a fuel cell 3.

The housing 2 forms an enclosure in which the fuel cell 3 is arranged and that is sealed against the ambient medium.

The fuel cell 3 comprises an anode 4 having an admission 41 and an anode discharge 42, a cathode 5 having an oxygen admission 51 and a cathode discharge 52, and a cooling system 6.

The fuel cell 3 is typically of the type having a high temperature proton exchange membrane, commonly referred to as a proton exchange membrane fuel cell (PEMFC).

In the description below, and by way of example, reference is made to a fuel cell involving a reaction associating hydrogen at the anode 4 and oxygen at the cathode 5. Nevertheless, this description can be transposed directly to any other type of fuel cell, providing it consumes oxygen, and the present invention should therefore not be interpreted as being limited to a single type of fuel.

The anode 4 of the fuel cell 3 is fed with hydrogen via its hydrogen admission 41, from a dedicated hydrogen supply. The hydrogen admission 41 of the anode 4 may for example be connected to the ambient medium via a check valve.

The cathode 5 of the fuel cell 3 is fed with oxygen via its oxygen admission 51, either by taking air from the ambient medium, or else from a dedicated oxygen supply. By way of example, the oxygen admission 51 of the cathode 5 may be connected to the ambient medium by means of a check valve.

The cooling system 6 as shown comprises a heat exchanger 61 arranged outside the sealed enclosure of the housing 2, e.g. possibly being associated with a fan, and thus cooling a heat-transfer fluid of the cooling system 6.

The operation of a fuel cell 3 of the PEMFC type is well known, but it is summarized briefly below by way of non-limiting example.

Hydrogen is taken to the anode 4, where it becomes dissociated into protons and electrons. The protons pass through the membrane of the fuel cell, while the electrons cannot pass through it, so they take a specific circuit, thereby generating electricity.

After passing through the membrane, the protons react with the oxygen of the cathode 5 so as to form water.

In the assembly 1 that is shown, the anode discharge 42 is connected to the ambient medium, or for example to the exhaust of an aircraft, if the assembly is used in an aircraft.

The cathode discharge 52 is connected to the inside volume of the sealed enclosure of the housing 2, such that the gas that is discharged after the reaction at the anode 4 is injected into the inside volume of the sealed enclosure.

In the embodiment shown, the assembly includes a condenser 7 that is connected to the cathode discharge 52 so as to separate water from the gas discharged by the cathode 5.

The gas discharged by the cathode 5 is then injected into the sealed enclosure of the housing 2, while the water is evacuated to the ambient medium, e.g. into the exhaust of an aircraft if the assembly is used in an aircraft.

The condenser 7 as shown further comprises a heat exchanger 71 arranged outside the sealed enclosure, possibly being associated with a fan, for example, thereby cooling a heat-transfer fluid flowing in the condenser 7.

The housing 2 typically includes an outlet orifice 8 with a rated valve 81, thus defining a maximum pressure value within the sealed enclosure of the housing 2.

In operation, the fuel cell 3 is put into service. The anode 4 is fed with hydrogen, and the cathode 5 is fed with oxygen, e.g. by taking air from the ambient medium.

The operation of the fuel cell generates electricity, and discharges water as described above, together with air that is oxygen-depleted, insofar as the reaction at the cathode consumes a fraction of the oxygen in the air passing through the fuel cell.

The cathode thus discharges both water and oxygen-depleted air via its cathode discharge 52. The oxygen-depleted air as discharged by the cathode 5 typically has an oxygen content of less than 9%. The water is captured by the condenser 7 and evacuated to the ambient medium, while the oxygen-depleted air is evacuated into the sealed enclosure of the housing 2.

The anode discharge 42 is connected to the ambient medium and thus evacuates gas leaving the anode 4 to the ambient medium, or else to a drain, in order to evacuate it from the aircraft if the assembly is used in an aircraft.

The sealed enclosure of the housing 2 thus becomes progressively filled with oxygen-depleted air as discharged by the cathode 5, thereby increasing pressure inside the sealed enclosure up to the threshold value defined by the rated valve 81, beyond which excess air is evacuated through the rated valve 81 to the ambient medium.

The sealed enclosure is thus progressively filled with substantially inert oxygen-depleted air.

FIG. 2 is a diagram showing these operating steps.

Tests have shown that in a volume filled in this way with oxygen-depleted air, so as to have an oxygen content of less than 10%, or indeed less than 9%, it is not possible to ignite a possible leak of hydrogen from the fuel cell 3.

The proposed assembly 1 thus makes it possible to make the fuel cell 3 safe, by placing it in an internal volume that becomes inert while the fuel cell is in operation.

The operation of the assembly 1 as proposed is also operation that is passive. It does not require a dedicated ventilation system nor does it require sensors requiring the fuel cell to stop in the event of a failure.

The assembly 1 as proposed can thus be used reliably in an aircraft. The assembly 1 may be arranged in a pressurized region of the aircraft, where pressure is typically maintained at about 0.8 bar. The rated valve 81 then typically defines a maximum pressure of 1 bar within the inside volume of the sealed enclosure of the housing 2, so as to establish an over-pressure of inert air inside the sealed enclosure of the housing 2 while the fuel cell 3 is in operation.

1. An assembly comprising a fuel cell arranged in a housing, the fuel cell comprising an anode having an admission and an anode discharge, and a cathode having an oxygen admission and a cathode discharge, the assembly comprising the housing and a sealed enclosure wherein the fuel cell is arranged and configured in such a manner that the gas discharged by the fuel cell is released into the sealed enclosure so as to generate an over-pressure of oxygen-depleted air inside the sealed enclosure.

2. The assembly according to claim 1, further comprising a condenser arranged inside the sealed enclosure and connected to the cathode discharge, the condenser being configured so as to collect water from the cathode discharge and to evacuate it to the outside of the housing, with the air from the cathode discharge being evacuated into the sealed enclosure of the housing.

3. The assembly according to claim 1, wherein the housing includes a rated valve configured to define a maximum pressure within the sealed enclosure, which pressure is higher than a predetermined ambient pressure.

4. The assembly according to claim 1, wherein the oxygen admission of the cathode is connected to the ambient medium by means of a check valve.

5. The assembly according to claim 1, wherein the fuel cell is a proton exchange membrane fuel cell.

6. The assembly according to claim 1, wherein the fuel cell further comprises a cooling system including a heat exchanger arranged outside the sealed enclosure of the housing.

7. The aircraft including an assembly according to claim 1, arranged in a volume of the aircraft that is pressurized at an ambient pressure.
